(19) United States
(12) Patent Application Publication
(10) Pub. No.: US 2023/0383995 A1
(43) Pub. Date: Nov. 30, 2023

(54) NONIMAGING ASYMMETRIC SHADELESS COLLECTOR

(71) Applicant: THE REGENTS OF THE UNIVERSITY OF CALIFORNIA, OAKLAND, CA (US)

(72) Inventors: Bennett WIDYOLAR, Merced, CA (US); Yogesh BHUSAL, Merced, CA (US); Jordyn BRINKLEY, Merced, CA (US); Lun JIANG, Merced, CA (US); Roland WINSTON, Merced, CA (US)

(21) Appl. No.: 18/030,729

(22) PCT Filed: Oct. 6, 2021
(86) PCT No.: PCT/US2021/053816

§ 371 Date: Apr. 6, 2023

Related U.S. Application Data
(60) Provisional application No. 63/088,392, filed on Oct. 6, 2020.

(51) Int. Cl. F24S 10/40; F24S 20/67; F24S 23/70

(52) U.S. Cl. CPC F24S 10/45; F24S 20/67; F24S 23/82; F24S 2020/16

(57) ABSTRACT

A solar collector comprising a wide-angle, nonimaging asymmetric optical reflector comprising a reflective film, an absorber assembly positioned within the optical reflector having a transparent tube evacuated to a vacuum or partial vacuum and at least two pipes with fluid flowing through the pipes, the pipes arranged in a flow-through configuration, wherein the solar acceptance angle of the collector is about 40 degrees, allowing for passive (stationary) solar tracking, and where the solar energy collected is transferred to the fluid in the form of heat. The fluid exiting the solar collector is in the range of 100° C. to 250° C., and the thermal energy of the fluid may be used to generate high-quality steam for solar industrial process heat applications.

### CROSS REFERENCE TO RELATED APPLICATIONS

Pursuant to 35 U.S.C. § 371, this application is a U.S. National Phase application of PCT/US2021/053816 filed Oct. 6, 2021, which claims priority pursuant to U.S.C. § 119(e) to U.S. provisional patent application No. 63/088,392, filed Oct. 6, 2020, which applications are specifically incorporated herein, in their entireties, by reference.

### FIELD OF THE INVENTION

The present invention generally relates to the field of solar collectors and solar concentrators. Specifically, embodiments of the present invention relate to novel solar collectors that utilize a wide-angle, nonimaging optical concentrator that is non-self-shading, thus eliminating the need for spacing between the collectors, and providing for efficient roof top and/or land use.

### DISCUSSION OF THE BACKGROUND

In the last two decades there have been two major solar energy success stories. The first is silicon photovoltaic collectors (PV), which has reached at least 700 GWₑₗ of installed capacity. The second is low temperature solar thermal collectors, which has reached at least 500 GWₜₕ, of installed capacity driven primarily by evacuated tube collectors (ETC) and flat plate collectors (FPC) for domestic hot water. These successes demonstrate how policy can trigger a self-reinforcing cycle of technology improvement and market expansion. Today PV is largely considered competitive with fossil fuels, and still reducing in cost.

Currently, about two thirds of the industrial process heat is consumed at temperatures below 250° C., which is ideally suited for solar thermal technologies. Despite this technical potential, solar thermal is not yet widely adopted because of the following key barriers to the use of the technology:
Cost: Solar projects must meet aggressive payback times required by industries, typically less than 5 years. Permitting and engineering can add significant cost to projects, which increase payback times beyond industry requirements.
Transport and land availability: Thermal energy can only be transported several hundred meters rather than hundreds of kilometers without inducing severe heat loss, thus reducing flexibility when locating projects. Many high consumption facilities do not have available land to co-locate a large solar field.
Simple and reliable operation: Ease of installation is key as additional construction can add significant cost and delay. Hiring someone to operate a solar field cuts into savings. End-users do not want to pay for a technology that requires frequent maintenance.

Achieving significant adoption of solar industrial process heat (SIPH) requires that technology overcome at least a majority of these barriers. The technologies which have become widely adopted worldwide, namely PV, flat-plate collectors (FPC) and evacuated tube collector (ETC) are simple to install and can be installed in small (as little as 1 KW) project sizes. Generally, large projects require significant upfront financing to provide cost reductions, and if financing fails to materialize, large projects may fail. Technologies that can enter the market at smaller scales have opportunities to demonstrate performance and learn with much lower risk, and can then rapidly scale up to achieve cost reductions.

The current U.S. Department of Energy, Solar Energy Technologies Office (SETO) goal for medium temperature process heat is $0.015/kWh compared to a natural gas price of $1/therm ($0.03/kWh), which provides for a 10 year payback time and a 294% 30 year internal rate of return (IRR). While the SETO goal provides a quicker payback time and higher IRR than residential PV technology, it is slightly less than commercial PV systems. Several technologies already offer quicker payback periods than PV. These other technologies, however, have not been adopted by the market on the same scale as PV because large industrial users often buy natural gas at a much lower wholesale price of $0.50/therm, thereby effectively doubling the solar payback times or halving the 30 year IRR. Additionally, the cost of land, permitting, or engineering is not factored in, which reduces returns. Thus, despite its potential, SIPH has yet to take hold in the market.

Therefore, it is desirable to provide modular (flexible), low cost, and high efficiency (as a function of land or roof area) solar thermal technologies.

### SUMMARY OF THE INVENTION

The present invention advantageously provides a modular, low cost and efficient solar thermal collector with the capability to effectively utilize 100% of available roof or land area, and generate medium temperature (250° C. or less) process heat. The Non-tracking, Asymmetric, Shadeless (NASH) collector has the capability to generate heat at more than 200° C., where it can be used for approximately two-thirds of process heat applications. In preferred embodiments, wide-angle, nonimaging asymmetric optical reflectors have a solar acceptance angle of approximately 40 degrees, allowing for passive (stationary) solar tracking and the capture of a portion of the diffuse solar energy, which can be significant in cloudy or polluted regions. Additionally, in typical embodiments, an evacuated tube absorber provides efficient operation regardless of the external environmental conditions. The combination results in a lightweight and low-cost thermal collector that is easily roof or ground mounted. In typical embodiments, a flow-through piping design for the absorber assembly reduces the total pipe, insulation, fluid and installation costs, and reduces heat loss through the interconnection piping.

It is therefore an object of the invention to provide a highly efficient solar collector at operating temperatures from about 100° C. to about 250° C. where the thermal energy may be used to generate high-quality steam for industry.

It is also an object of the invention to provide a solar thermal collector with flexible installation and easy integration into industrial operations.

It is further an object of the invention to provide a modular solar collector that may be installed on a small or large scale, with the capability to deliver significant reduction in carbon emissions.

It is a further object of the invention to provide a low-cost thermal solar collector with a fast (less than 5-year) payback time.

It is a further object of the invention to provide a solar thermal collector with greater than a 50% thermal efficiency.

It is further an object of the invention to provide a thermal solar collector with an evacuated absorber having vacuum stability over a 30-year lifetime.

It is further an object of the invention to provide a solar collector that reduces the cost of solar heat below the SETO goal of $0.015 kWh.

It is to be understood that both the foregoing general description and the following detailed description are exemplary, but not restrictive, of the invention. A more complete understanding of the improved solar thermal collector and the methods disclosed herein will be afforded to those skilled in the art.

### BRIEF DESCRIPTION OF THE DRAWINGS

FIG. 1 is a cross-sectional schematic diagram of four NASH collectors mounted on a flat roof, according to an embodiment of the invention.

FIG. 2A is a schematic diagram of a rooftop installation showing required spacing for conventional tilted collectors due to the incident angles of the sun during the summer, equinox and winter.

FIG. 2B is a schematic diagram of a rooftop installation showing the NASH collector's maximum roof utilization of the roof area.

FIG. 3 is a cross-sectional view showing the shape of the NASH collector according to an embodiment of the invention.

FIG. 4 is a perspective view of the bottom side of a reflector with two ribs according to an embodiment of the invention.

FIG. 5 is a perspective view of a NASH collector, showing an absorber, reflector and ribs according to an embodiment of the invention.

FIG. 6A shows a cross-section of a NASH collector and shape deformation data, according to an embodiment of the invention.

FIG. 6B is a perspective view of the deformed shapes of FIG. 6A.

FIG. 6C is a graph of ray tracing results based on the deformation data of FIG. 6A.

FIG. 7 shows heat transfer to an absorber and fluid flowing in and out of two pipes inside the absorber, according to an embodiment of the invention.

FIG. 8A is a graph showing propylene glycol fluid temperatures as a function of time.

FIG. 8B is a graph showing an efficiency curve for the NASH collector using propylene glycol as the heat transfer fluid.

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications, and equivalents that may be included within the spirit and scope of the invention. Furthermore, in the following detailed description of the present invention, numerous specific details are set forth in order to provide a thorough understanding of the present invention. However, it will readily be apparent to one skilled in the art that the present invention may be practiced without these specific details.

Embodiments of the present invention advantageously provide a novel solar thermal collector that is low-cost and non-tracking (the collectors do not move with the movement of the sun), and maximizes land (or rooftop) use of the solar field by eliminating the need for collector tilting, and which may generate heat at more than 200° C., thereby providing heat necessary for approximately two thirds of the process heat applications.

Embodiments of the NASH collector typically comprise: (1) a wide-angle, non-imaging asymmetric optical reflector comprising a reflective film; and (2) an absorber assembly positioned within the optical reflector. The absorber assembly typically comprises: (a) a transparent tube evacuated to a vacuum or partial vacuum; and (b) at least two pipes inside the transparent tube, each of the at least two pipes having a fluid flowing through the pipe, wherein solar energy is transferred to the fluid in the form of heat, the optical reflector is non-shading (i.e., the reflector does not cast shadows on adjacent collectors/reflectors), and an aperture of the reflector is parallel to a surface on which the solar collector is mounted.

Because the NASH reflectors/collectors are non-shading, they may be placed adjacent to one another on a surface with little or no space between the collectors, thereby providing for efficient use (100% or nearly 100%) of the area designated for the solar collection.

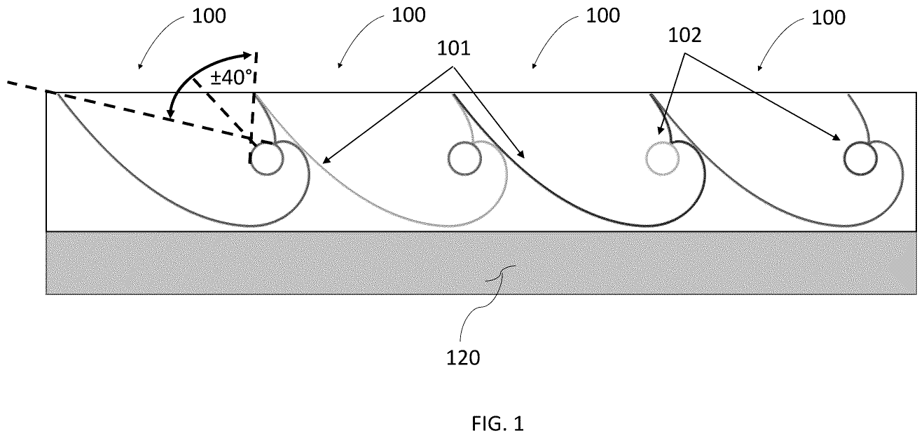

Referring now to FIG. 1, therein is shown a schematic view of four NASH collectors 100 mounted on a rooftop. Each of the NASH collectors 100 comprises a wide-angle, nonimaging, asymmetric optical reflector 101 and an absorber assembly 102. The optical reflector 101 typically comprises a reflective coating to concentrate light rays, which may comprise one or more metals, (e.g., ALANOD MICRO-SUN® or another ALANOD® coating, a film coating (e.g., REFLECTECH®, MYLAR®, etc.), physical vapor deposition (PVD) coatings (e.g., aluminum, silver, tin chloride, etc.), or other reflective film or coatings that have a solar reflection of about 75-90% or more).

The absorber assembly 102 is positioned within the optical reflector 101 and generally comprises a transparent tube, evacuated to a vacuum or partial vacuum, which allows light rays to penetrate to the interior of the housing. In some other embodiments, the interior of the housing may comprise an inert gases (e.g., argon, helium, radon, etc.) In these embodiments, the inert gas most typically is argon at atmospheric pressure (1 atm.), although other gases and pressures may also be utilized.

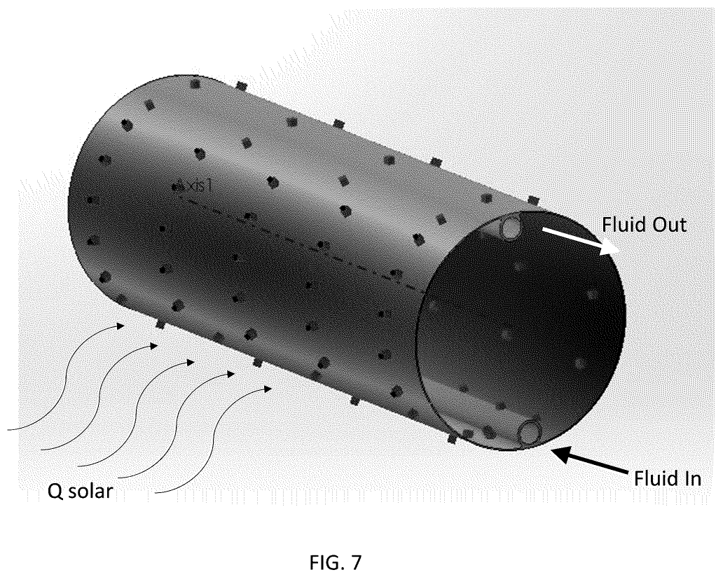

The absorber assembly may be glass, PLEXIGLASS, polycarbonate, acrylic and/or other plastic materials having a high degree of light transmission, clarity and strength at the operating temperatures of the solar collectors discussed herein. Two or more pipes run inside the transparent tube, which absorb the thermal energy to produce heat, typically in a “flow-through” design configuration (see e.g., FIG. 7). Each of the two or more pipes has a fluid flowing through it, in opposite directions from the other pipe, wherein solar energy in the form of heat is transferred to the fluid in the pipes. In typical embodiments the absorber is approximately 2 meters long and has a perimeter of approximately 272 mm, although the length may vary by +/− about a meter and the perimeter may vary from about 100 mm-450 mm. In typical embodiments, the fluid may be water, propylene glycol, ethylene glycol, acetone, methanol or a mixtures thereof, and hot fluid temperatures out of the absorber may range from about 100° C. to 250° C.

Because of the novel shape of its reflectors, the accepted range of the sun's position is approximately 40 degrees. This wide-angle optical design allows the NASH collectors to remain stationary as the optics provide passive solar tracking. This eliminates capital, operating, and maintenance costs associated with active trackers (collectors that move with the movement of the sun). It also allows the collector to capture a portion of the diffuse solar energy, which can be significant in cloudy or polluted regions. It also reduces assembly, material, and installation requirements and enables operation in dusty conditions. The evacuated tube absorber provides thermal efficient operation regardless of external environmental conditions. The combination results in a lightweight and low-cost non-tracking solar thermal collector, which is easily roof mounted for flexible use of available roof space.

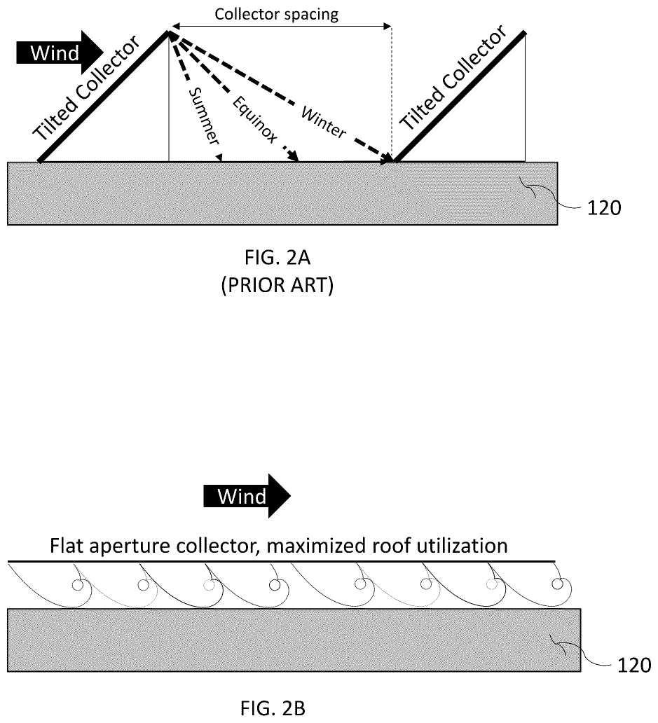

The wide-angle optical design also allows NASH collectors to be placed adjacent to each other, without the need for spacing the collectors, thereby utilizing one hundred or nearly one hundred percent (100%) of a roof's area. This is best seen in reference to FIGS. 2A and 2B. FIG. 2A shows a diagram of conventional tilted collectors, which requires that the collectors be separated from each other to prevent summer and winter shading. Thus, conventional tilted collectors waste roof and land space because of the distance between them.

As illustrated in FIG. 2B, the NASH collector is innovative for two reasons. First, the nonimaging reflector profile has a horizontal (flat) aperture so that it can be installed flat on a flat roof or surface, or parallel to the roof or surface if not the surface is not horizontal. This prevents self-shading (thus the NASH collector is “shadeless”) and eliminates the need for collector row spacing, allowing much higher thermal production density or thermal generation per installed land area. Thus, NASH collectors maximize the energy generation per roof (or land) area using much tighter module packing.

The low-profile collector provides several additional benefits. Wind loading will be much lower than with tilted collectors, and the low-profile collector reduces costs associated with collector mounting and/or racking.

Second, vacuum tubes currently used in conventional solar thermal collector technologies have been traditionally manufactured with fluid pipes in a U-tube configuration. A U-tube configuration, however, results in excessive solar field plumbing and thermal efficiency reductions up to one-third due to piping heat losses and the additional heat capacity of materials, which must be heated to operating temperatures.

In contrast, the NASH collector typically utilizes a flow-through configuration that incorporates the solar field distribution piping into the active collecting area of the collector. This eliminates a significant amount of piping, which has the dual effect of reducing total pipe, insulation, fluid, and installation costs as well as increasing the solar field thermal efficiency by reducing heat losses. To accommodate the thermal expansion in the vacuum tube due to the flow-through piping design, flexible copper pipes and/or tubes, or stainless steel bellows are utilized.

Imaging optical systems (e.g., parabolic troughs) require high optical accuracy to provide solar concentration. Typical angular tolerance with such systems is +/−1 degree to provide solar concentration. This requires foundational and structural material costs to maintain optical accuracy during normal wind loading, and may account for nearly half of the installed system cost.

On the other hand, the NASH collector has a wide angular acceptance (+/−40 degrees) which reduces structural requirements and allows for tolerance in module assembly and installation. It also allows much lower cost semi-specular mirror materials to be used instead of the high specular mirror materials required by high accuracy systems.

Vacuum receiver tubes used in conventional solar industrial process heat (SIPH) collectors (e.g., parabolic troughs) are built using housekeeping seals with heavy bellows to accommodate thermal expansion resulting from a temperature rise of 400° C. to 550° C. during vacuum baking. The vacuum receiver (absorber) tubes utilized in the NASH collector may be customized for medium temperature applications (up to 250° C.), allowing for the use of lighter bellows and/or flexible copper piping. Optimization of the metal-to-glass seal and heat transfer enables an approximately 7-10 times cost reduction for the NASH collector's medium temperature vacuum absorbers per selective absorber area (see e.g., the metal to glass seal of WO 2020/159613 A1, published Aug. 6, 2020, incorporated herein by reference).

The NASH design greatly simplifies installation, which may be as simple as laying down a module flat on a roof and tying together the plumbing connections (which, for example, may be quickly installed copper flare fittings, or other types of quick pipe and/or tube connectors or couplings). A typical installation speed of approximately 4 to 6 m 2 per man hour reduces installation costs. The labor required for assembly of the module is also reduced compared to conventional SIPH collectors.

The NASH collector design is a horizontal aperture solar thermal collector that is easily installed in a bolt-on scenario on a building roof. While not integrated into the building envelope, in typical embodiments, the NASH collector is approximately 1 foot tall and has a flat top which is much more “integrated” into a building than, for example, a parabolic trough. Therefore, the NASH collector provides an option for consumers not interested in a solar energy system that is visible on the roof.

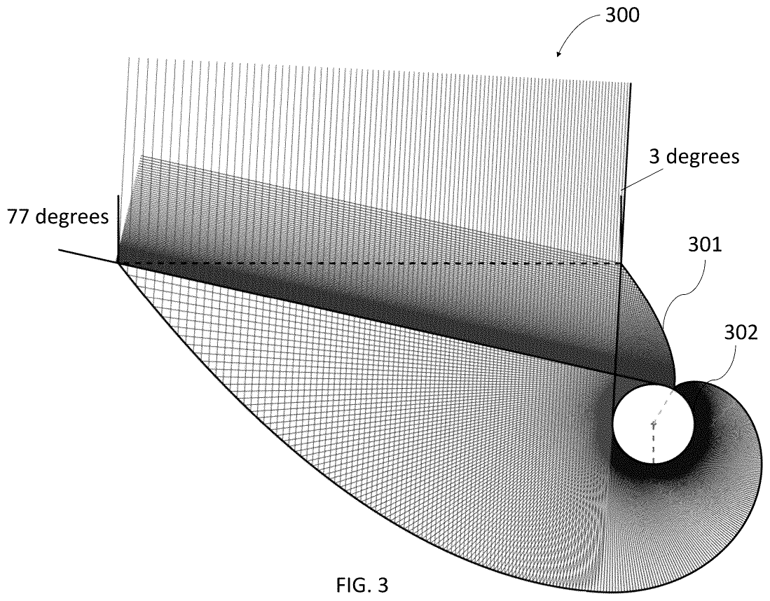

Referring now to FIG. 3, therein is shown a cross section of a typical NASH collector having a horizontal aperture and a absorber (vacuum tube) positioned at +3 degrees north and +77 degrees south according to an embodiment of the invention. Positioned as such, the NASH collector has a solar acceptance angle of approximately +/−40 degrees from a latitude of 37 degrees north. NASH collectors may also be adapted for any angle of roof (or ground) inclination, and the positioning of the absorber tube in the collector may vary depending on the application.

In some embodiments, the absorber assembly may comprise a circular cross-section. In other embodiments, the absorber may be conical, parabolic, diamond, hexagonal, decagonal, oval, square, rectangular or other polygonal or geometric-shaped cross-section, and having a high transparency and low thermal expansion rate. The absorber assembly also comprises at least two pipes, which are typically copper. The outer diameter of the absorber assembly, if circular, may range from 25 mm to about 125 mm. Other types of absorbers may also be utilized. For example, in some embodiments, a copper absorber may be utilized, having two copper channels within the absorber. The copper channels may range from about 3 mm to about 12.5 mm inner diameter (typically about 6.5 mm), and about 4.0 mm to 17 mm outer diameter (typically about 8 mm) and may be attached (e.g., by ultrasonic welding) to the absorber. In other embodiments, the absorber may be a metal pipe absorber.

The cross-sectional shape of the reflector may also vary. Particularly those embodiments having an absorber with a non-circular cross-section, the cross-sectional shape of the reflector may comprise arcs of varying lengths and radii, connected at endpoints. In some embodiments, the cross-sectional shape of the reflector may also comprise one or more irregularly shaped portions. In any case, the reflector has a wide acceptance angle, and generally has a flat aperture.

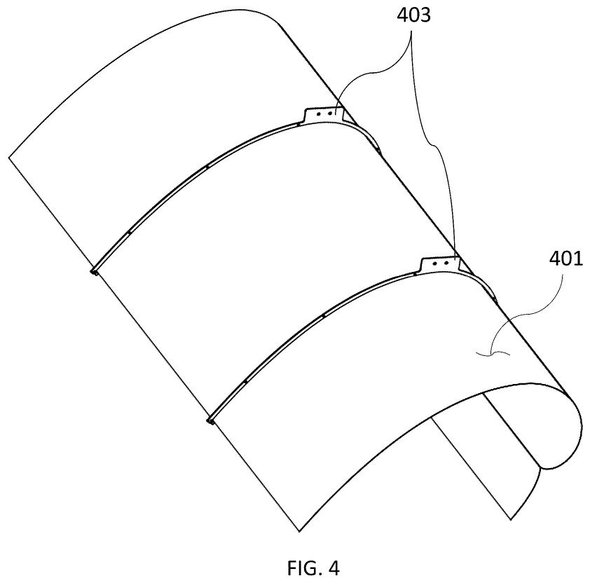

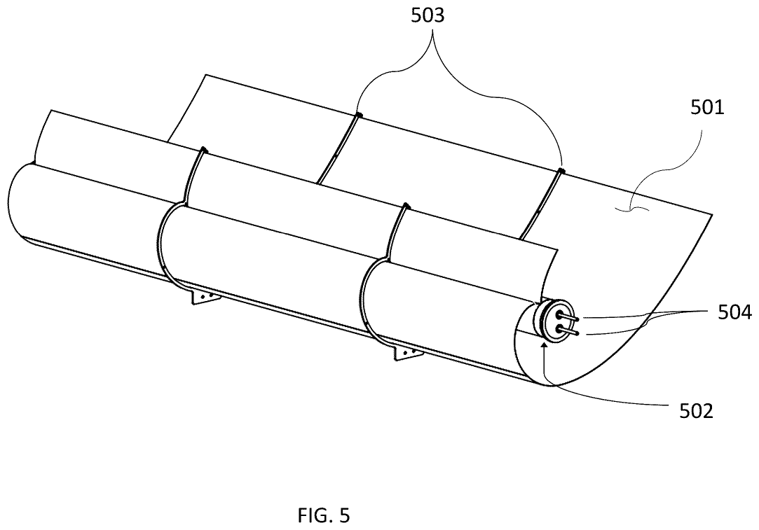

FIG. 4 is a perspective view of a bottom side of a reflector 401 having two ribs 403. In FIG. 4, the aperture (opening) of the reflector 401 is facing downward in order to more clearly show its shape and its accompanying ribs 403. However, in use, the aperture of the reflector faces upward, and is parallel or approximately parallel to the surface on which the NASH collector is mounted. For example, on a flat roof, the aperture would be horizontal (see e.g., FIG. 1). In embodiments having ribs, the ribs 403 act as a support structure for the reflective film, which may be formed around the ribs of the collector, and which aid in maintaining the shape of the reflector film. The ribs also allow for easy of mounting to a roof or support structure. The number of ribs may vary, from two ribs to six ribs or more, depending on the length of the reflector and the stiffness of the reflector film. Typically, a NASH collector has between two to four ribs.

In some embodiments, the ribs 403 may be aluminum and/or an aluminum alloy, a polymer (e.g., polyethylene, polypropylene, polystyrene, polycarbonate, polyvinyl chloride (PVC), or a combination thereof) and/or fiberglass. The ribs may be coated with a mirror film having a high reflectance across the solar spectrum (e.g., REFLECTECH®, or other reflective film with a high reflectance value). In embodiments not having ribs, the reflector film and substrate on which the film is applied, if any, are formed to an asymmetric shape (see e.g., the reflector cross-section of FIG. 3).

In some embodiments, the absorber assembly will comprise glass, PLEXIGLASS, polycarbonate, acrylic and/or other plastic materials having a high degree of light transmission, clarity and strength at the operating temperatures discussed herein. Most typically, the absorber assembly will comprise borosilicate and/or soda lime glass. Borosilicate (also called PYREX) glass is a low iron glass with a high transparency (91.8% transmissivity) and low thermal expansion rate (3.3e-6 m/m ° C.). Because of these properties, borosilicate glass may be used in preferred embodiments.

FIG. 5 is a perspective view of a NASH collector comprising a wide-angle, nonimaging, asymmetric optical reflector 501, an absorber assembly 502, ribs 503 and inlet and outlet piping 504, according to an embodiment of the invention. The aperture (opening) of the collector is completely absorbing within the acceptance angle. Outside of the acceptance angle, the collector is completely reflective.

In typical embodiments, the NASH collector may be about 2 meters long, by about 0.5 meters wide by about 1 meter tall. On other embodiments, however, the NASH collector may be between about 1 meter to about 3 meters long, from about 0.2 meters to 1.0 meter wide, and from about 0.16 meters to about 1.00 meters tall.

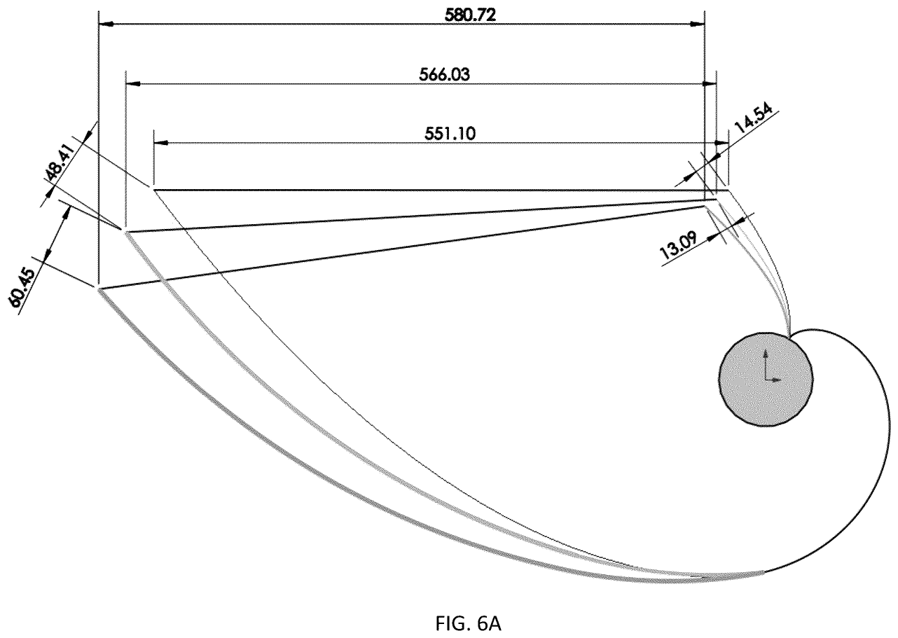

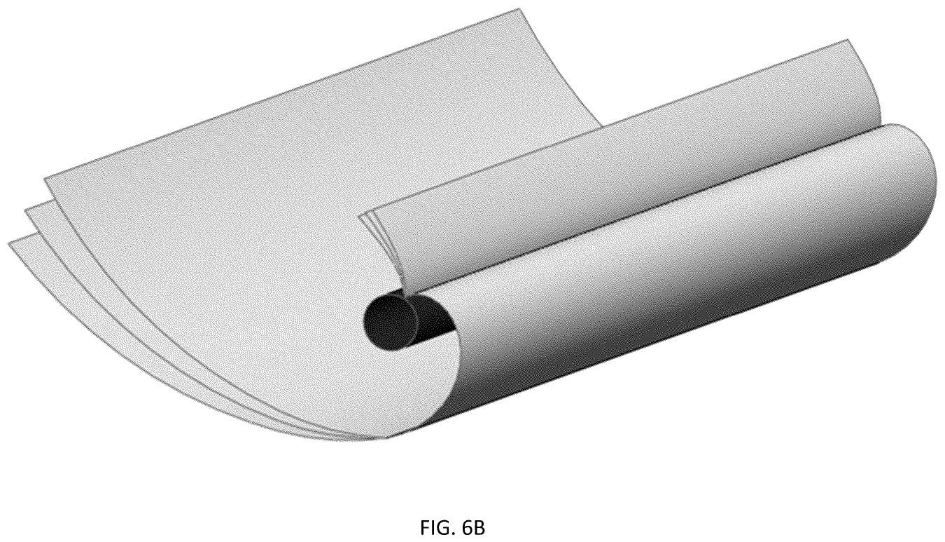

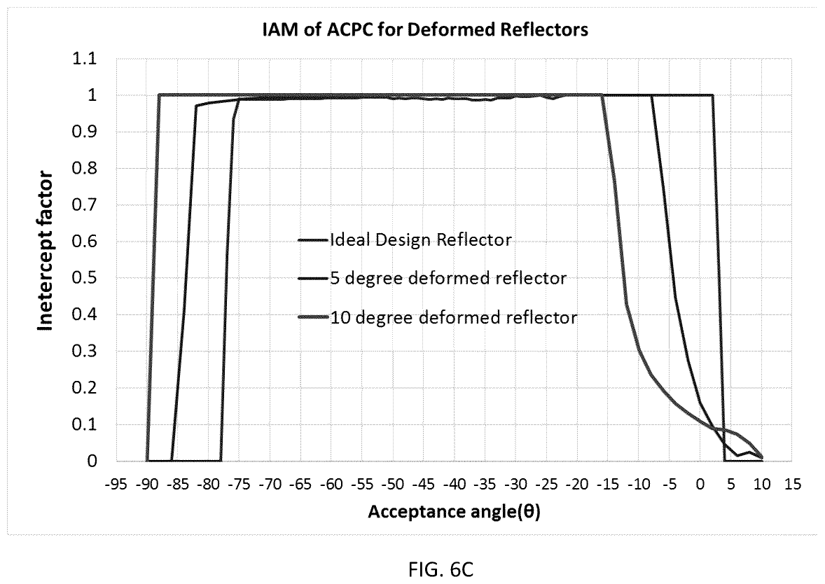

FIG. 6A shows a typical cross-section of the NASH collector and shape deformation data. Deformation of the collector may be caused by wind or snow loading, and in some embodiments, may be a desired feature of the design. Due to the highly tolerant optical design, in some embodiments, the reflector shape may be intentionally deformed to accommodate project conditions in various locations and/or projects having various physical constraints. This highly-tolerant optical design allows for the use of a single manufacturing line for multiple installation positions, thus reducing or eliminating the cost of retooling for each installation.

Perspective views of the various deformed shapes of FIG. 6A are shown in FIG. 6B, and ray tracing results based on the deformation data of FIG. 6A is shown in FIG. 6C. Specifically, FIG. 6C represents the incident angle modifier (IAM) for the asymmetric shadeless reflector (concentrator) of the NASH collector as a function of the acceptance angle and the intercept factor.

FIG. 7 shows heat transfer of an absorber assembly having a circular cross-section. In some embodiments, the temperature of the absorber assembly may range from about 300° C. to about 350° C. Also shown in FIG. 7 is the typical directional flow of the fluid in the pipes inside the absorber.

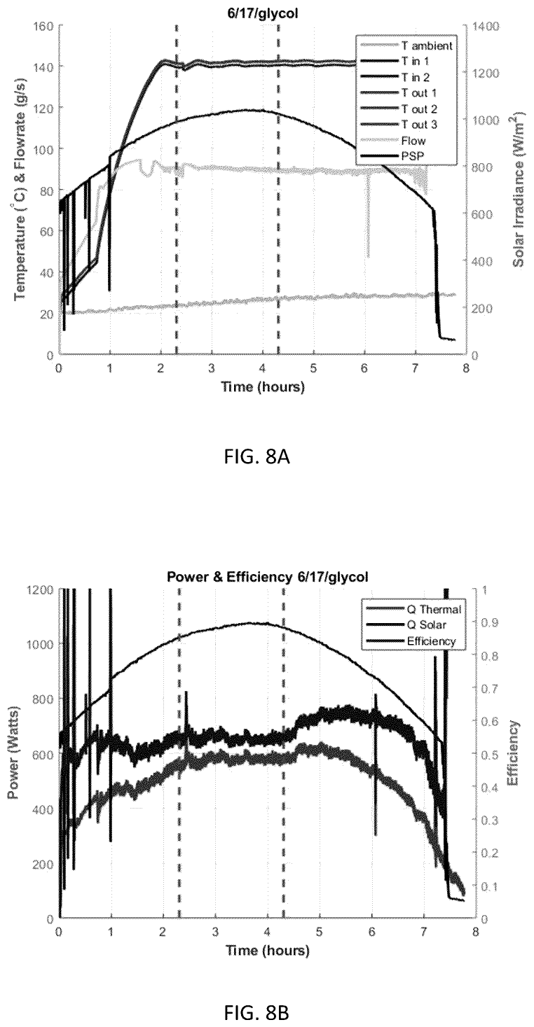

FIG. 8A is a graph showing the relationship between solar irradiance, flowrate and temperature of propylene glycol as a function of time. FIG. 8B is a graph of the thermal efficiency of the NASH collector using propylene glycol operating at a temperature of 140° C. and a flowrate of approximately 90 gallons per second (gps). Operating temperatures of the fluid within the pipes of the absorber may vary from about 100° C. to about 250° C., and flowrates may vary from about 30 gps to 150 gps. Typically, the NASH collector has an optical efficiency of about 60% using water as the heat transfer fluid, and a thermal efficiency of about 55% using propylene glycol operating at 140° C.

A plurality of NASH collectors may also be arranged into a solar collection system. A typical NASH solar collection comprises a plurality of solar collectors, each solar collector comprising (1) a wide-angle, non-imaging asymmetric optical reflector comprising a reflective film; and (2) an absorber assembly positioned within the optical reflector, the absorber comprising: (a) a transparent tube evacuated to a vacuum or partial vacuum; and (b) at least two pipes inside the transparent tube, each of the at least two pipes having a fluid flowing through the pipe, wherein solar energy is transferred to the fluid in the form of heat, and each solar collector is non-shading and is placed adjacent to one or more other solar collectors with little or no space between the collectors.

As with each NASH collector, the aperture of the optical reflector may be parallel to a surface on which the solar collector is mounted, and the optical reflector's acceptance angle may be approximately 40 degrees. Other properties/characteristics of each NASH collector may be as described above for an individual NASH collector.

Thus, the NASH collector advantageously provides modular, low cost and efficient solar thermal collectors with the capability to effectively utilize 100% of available roof or land area, and efficiently generate medium temperature process heat up to 250° C.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A solar collector, comprising:
a wide-angle, non-imaging asymmetric optical reflector comprising a reflective film; and
an absorber assembly positioned within the optical reflector, the absorber assembly comprising:
a transparent tube evacuated to a vacuum or partial vacuum;
at least two pipes inside the transparent tube, each of the at least two pipes having a fluid flowing through the pipe, wherein solar energy is transferred to the fluid in the form of heat; and
wherein the optical reflector is non-shading and an aperture of the reflector is parallel to a surface on which the solar collector is mounted.

2. The solar collector of claim 1, wherein a solar acceptance angle of the optical reflector is approximately 40 degrees.

3. The solar collector of claim 1, wherein a temperature of the fluid exiting the absorber ranges from about 100° C. to about 250° C.

4. The solar collector of claim 1, wherein the at least two pipes are arranged in a flow-through configuration.

5. The solar collector of claim 4, wherein the at least two pipes comprise flexible copper.

6. The solar collector of claim 1, wherein one or more of the solar collectors are placed adjacent to one another on the surface with little or no space between the collectors.

7. The solar collector of claim 1, wherein the fluid is water, propylene glycol, or a mixture thereof.

8. The solar collector of claim 1, wherein the solar collector is non-tracking.

9. The solar collector of claim 1, further comprising at least two ribs, wherein the reflective film conforms to a shape of the at least two ribs.

10. The solar collector of claim 1, wherein the optical reflector has a horizontal aperture.

11. A solar collector system, comprising:
a plurality of solar collectors, each solar collector comprising:
a wide-angle, non-imaging asymmetric optical reflector comprising a reflective film; and
an absorber assembly positioned within the optical reflector, the absorber assembly comprising:
a transparent tube evacuated to a vacuum or partial vacuum;
at least two pipes inside the transparent tube, each of the at least two pipes having a fluid flowing through the pipe, wherein solar energy is transferred to the fluid in the form of heat;
wherein each solar collector is non-shading and is placed adjacent to one or more of other solar collectors with little or no space between the collectors.

12. The solar collector system of claim 11, wherein the aperture of the optical reflector is parallel to a surface on which the solar collector is mounted.

13. The solar collector system of claim 11, wherein an acceptance angle of the optical reflector is approximately 40 degrees.

14. The solar collector system of claim 11, wherein a cross-section of the transparent tube is circular.

15. The solar collector system of claim 11, wherein each solar collector further comprises at least two asymmetric ribs and the reflective film conforms to a shape of the at least two asymmetric ribs.

16. A solar collector, comprising:
a wide-angle, non-imaging asymmetric optical reflector having a horizontal aperture and comprising a reflective film; and
an absorber positioned within the optical reflector, wherein solar energy is transferred in the form of heat to a fluid flowing through the absorber; and
wherein the optical reflector is non-shading such that when a plurality of solar collectors are placed adjacent to one another there is little or no space between the collectors.

17. The solar collector of claim 16, wherein an aperture of the optical reflector is parallel to a surface on which the solar collector is mounted.

18. The solar collector of claim 16, wherein the absorber comprises:
a transparent tube evacuated to a vacuum or partial vacuum;
at least two pipes inside the transparent tube, each of the at least two pipes having a fluid flowing through it.

19. The solar collector of claim 18, wherein the fluid is water, propylene glycol, or a combination thereof.

20. The solar collector of claim 18, wherein a temperature of the fluid exiting the absorber ranges from about 100° C. to about 250° C.
